(19) United States
(12) Patent Application Publication
(10) Pub. No.: US 2024/0355573 A1
(43) Pub. Date: Oct. 24, 2024

(54) ELECTRICAL ISOLATION OF DEVICES OPERATING AT CRYOGENIC TEMPERATURES

(71) Applicant: IonQ, Inc., College Park, MD (US)

(72) Inventors: Ismail Volkan INLEK, Kensington, MD (US); Daniel ZAMBRANO, Washington, DC (US)

(21) Appl. No.: 18/339,809

(22) Filed: Jun. 22, 2023

Related U.S. Application Data
(60) Provisional application No. 63/366,992, filed on Jun. 24, 2022.

(51) Int. Cl. H01J 3/38; G06N 10/40; H01J 7/24; H01J 49/42

(52) U.S. Cl. CPC H01J 3/38; G06N 10/40; H01J 7/24; H01J 49/4245; H01J 49/4255

(57) ABSTRACT

Aspects of the present disclosure relate generally to systems and methods for use in the implementation and/or operation of quantum information processing (QIP) systems, and more particularly, to provide a cold finger for use with a quantum information processing (QIP) system including a cryostat. The cold finger includes a planar base including a first surface proximate a cooling plate of the cryostat opposite a second surface; a finger including a first end coupled to the second surface of the planar base and a second end configured to engage an ion trap; and an isolation unit positioned above the cooling plate of the cryostat and including a dielectric crystal plate that is configured to isolate the ion trap from electrical noise generated by the cryostat when controlling a temperature of the ion trap.

### CROSS-REFERENCE TO RELATED APPLICATION

This application claims the benefit of U.S. Provisional Patent Application No. 63/366,992, filed Jun. 24, 2022 and hereby incorporates by reference herein the contents of this application.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of providing electrical isolation to QIP systems cooled by a cryostat, while allowing high thermal conductivity between the cryostat and components of the QIP system.

In some aspects of the disclosure, a cold finger for use with a quantum information processing (QIP) system including a cryostat includes a planar base, a finger, and an isolation unit. The planar base includes opposing first and second surfaces. The finger includes a first end coupled to the second surface of the planar base and a second end configured to engage an ion trap. The isolation unit includes a dielectric crystal plate that is configured to isolate the ion trap from electrical noise generated by the cryostat when the cryostat is controlling a temperature of the ion trap.

In some aspects of the disclosure, an isolation unit for use with a quantum information processing (QIP) system including a cryostat includes a dielectric crystal plate. The dielectric crystal plate is configured to be positioned between a cooling plate of the cryostat and a component to be isolated. The dielectric crystal plate has a first surface, a second surface opposite the first surface, a first indium layer overlying the first surface, and a second indium layer overlying the second surface. The isolation unit is configured to facilitate thermal conductivity between the cooling plate and the component to be isolated and prevent electrical noise between the cooling plate and the component to be isolated.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates a perspective view of an example QIP system including an example cryostat coupled to an example cold finger and an example isolation unit in accordance with aspects of this disclosure.

FIG. 5 illustrates a section view of the example QIP system of FIG. 4 taken along lines 5-5 of FIG. 4.

FIG. 6 illustrates a perspective view of an example cold finger for use with a QIP system in accordance with aspects of this disclosure.

FIG. 7 illustrates a section view of an example cold finger and isolation unit for use with a QIP system in accordance with aspects of this disclosure.

FIG. 8 illustrates an exploded view of an example isolation unit for use with a QIP system in accordance with aspects of this disclosure.

FIG. 9 illustrates an example isolation unit for use with a QIP system in accordance with aspects of this disclosure.

FIG. 10 illustrates an example plot of a heat load response of a cold finger coupled to a cryostat without an isolation unit in accordance with aspects of this disclosure.

FIG. 11 illustrates an example plot of a heat load response of a cold finger coupled to a cryostat with an isolation unit in accordance with aspects of this disclosure.

FIG. 12 illustrates an example plot of noise reduction versus frequency when the cryostat is turned off in accordance with some aspects of the disclosure.

FIG. 13 illustrates an example plot of noise reduction versus frequency when the cryostat is turned on in accordance with some aspects of the disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

QIP systems typically are used in conjunction with cryostats to cool atomic ions in a linear crystal or chain in an ion trap to cryogenic temperatures, as described in greater detail below. Cooling the ion trap to cryogenic temperatures is advantageous because it significantly reduces both density and motional energy of gas molecules inside the ion trap. Consequently, this reduced collision rate and energy transfer to ions enables working with chains of up to 40 ions for several days before the ion chain needs to be re-loaded. However, the motors, compressors, and other components of the cryostat can generate electrical noise and mechanical vibrations that can travel to the ions in the ion trap, which may disrupt (e.g., cause motion of, displace, etc.) the ions in the ion chain, which could lead to errors in operation of the QIP.

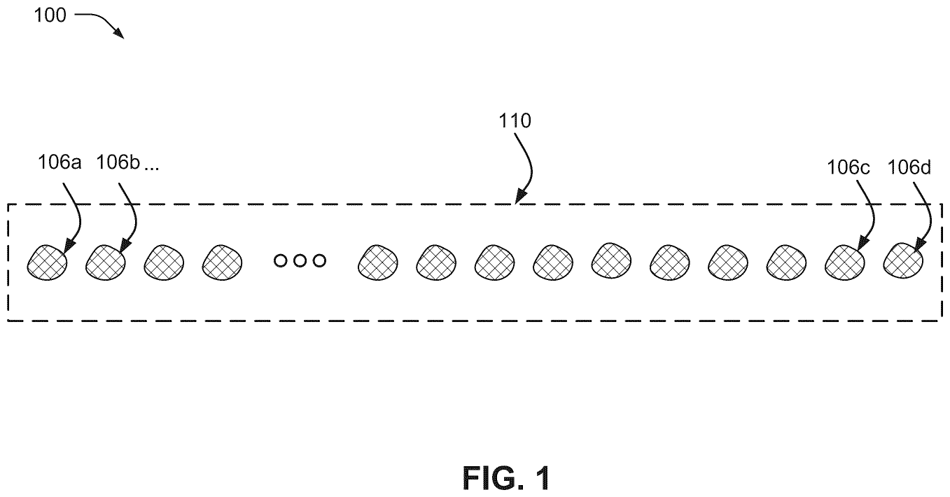

Solutions to the issues described above are explained in more detail in connection with FIGS. 1-8, with FIGS. 1-3 providing a background of QIP systems or quantum computers, and more specifically, of atomic-based QIP systems or quantum computers.

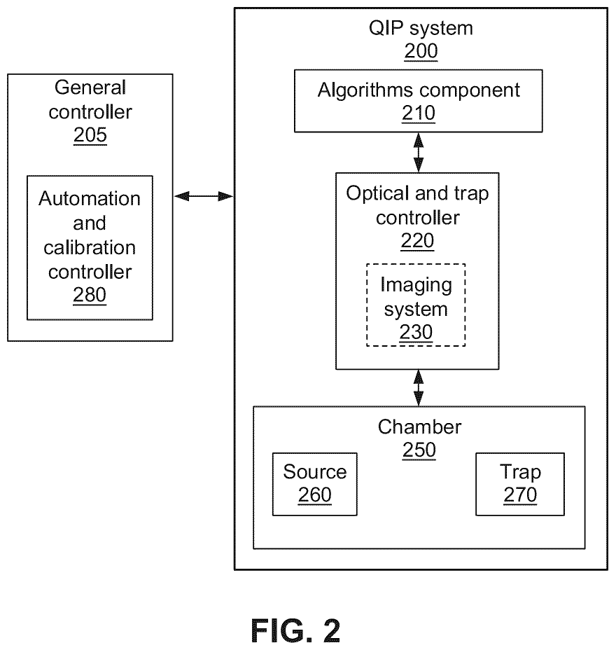

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially to cool the trap 270 to cryogenic temperatures as described in greater detail below.

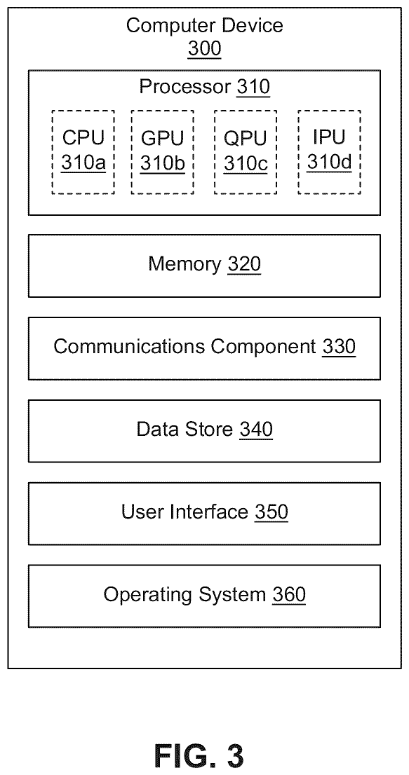

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, a cryostat 400 coupled to the QIP system 200 is configured to cool the ion trap 270 to cryogenic temperatures to significantly reduces both motional noise on the trapped ions, and motion of gas molecules inside the ion trap 270. As described in greater detail herein, an isolation unit 600 is configured to isolate the ion trap 270 from electrical noise generated by motors, compressors, and other components of the cryostat 400, thereby reducing an amount of disturbance they may cause to the trapped ions in the ion chain in the ion trap 270. Although the isolation unit 600 is described in connection with the ion trap 270, it is contemplated that the isolation unit 600 can also used to isolate other components coupled to the cryostat 400 that are sensitive to electrical noise.

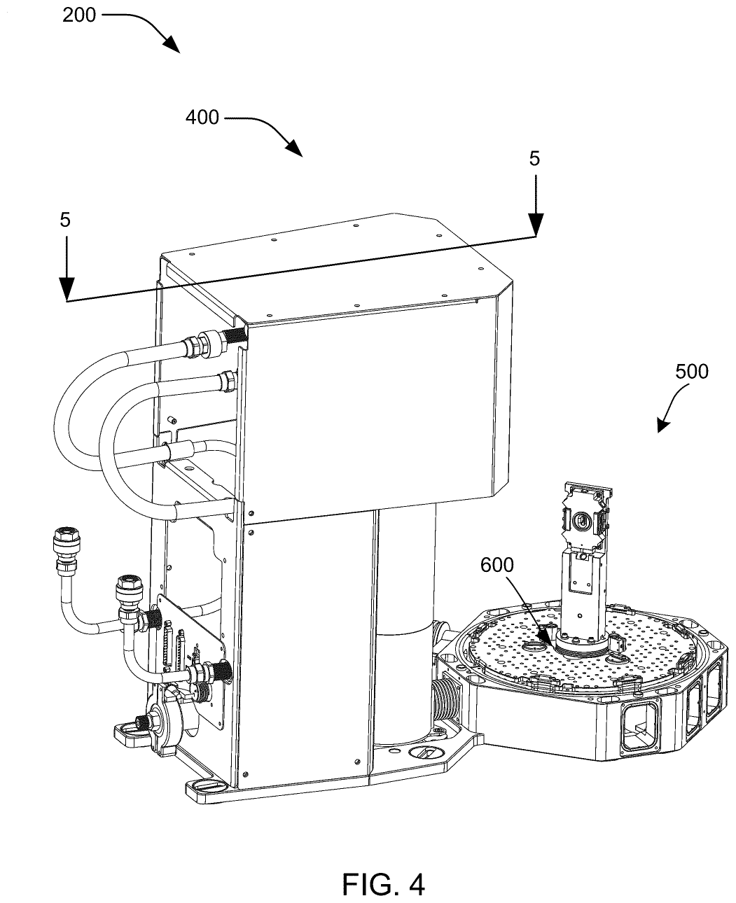

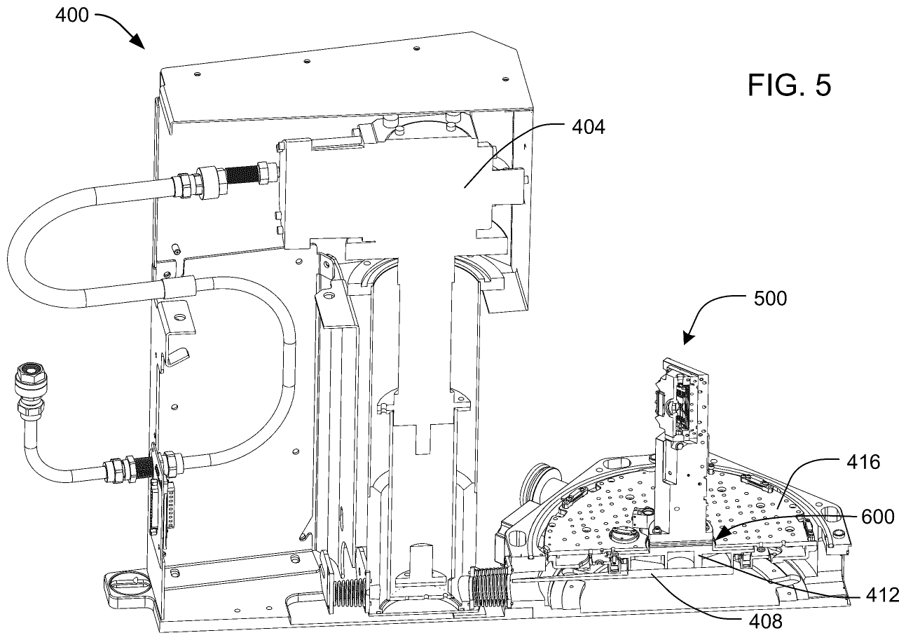

FIG. 4 illustrates a perspective view of an example QIP system 200 including an example cryostat 400 coupled to an example cold finger 500 and an example isolation unit 600. FIG. 5 illustrates a section view of the example QIP system 200 taken along lines 5-5 of FIG. 4. In FIGS. 4 and 5, several components of the QIP system 200 are not shown to better show the arrangement of the cryostat 400 and the cold finger 500.

As shown in FIGS. 4 and 5, the cryostat 400 includes a cryocooler 404 (including one or more compressors, not shown), a thermal connection 408, a first plate 412, and a second plate 416. As shown in FIG. 5, the thermal connection 408 is coupled between the cryocooler 404 and the first and second plates 412, 416 to cool the first and second plates 412, 416. In some aspects, the first plate 412 may be cooled to approximately 4 Kelvin (K). In some aspects, the second plate 416 may be cooled to approximately 100 K. Components may be mounted to the first and second plates 412, 416 to cool the components via conductive heat transfer. For example, the isolation unit 600 and the cold finger 500 may be coupled to the first plate 412, as shown in FIGS. 4 and 5.

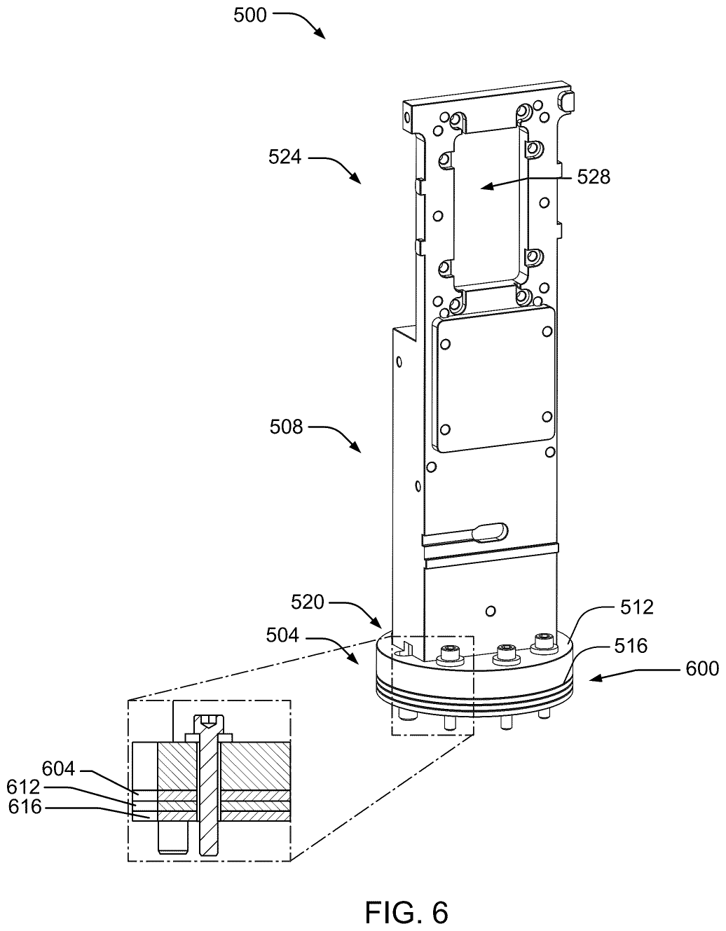

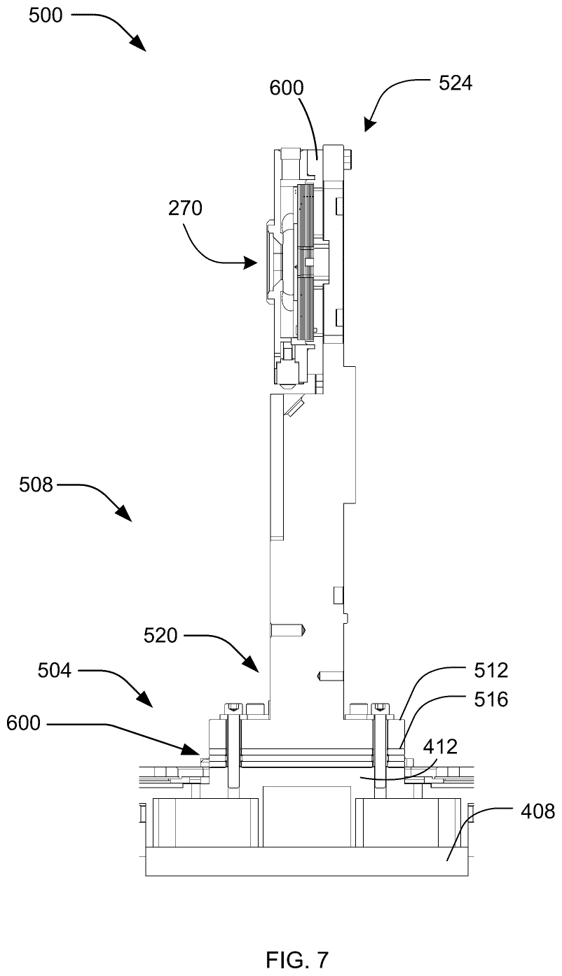

Referring now to FIGS. 6 and 7, the cold finger 500 includes a base 504 and a finger 508. The base 504 is substantially planar and includes a first surface 512 configured to face the first plate 412 (FIG. 7) of the cryostat 400 and a second surface 516 opposite the first surface 512. In the illustrated aspect, a cross-sectional shape of the base 505 is substantially circular. In other aspects, the cross-sectional shape of the base 504 may be a different geometric shape, such as rectangular, triangular, square, oval, ellipsoid, and so forth. The cold finger 500 may be or include a material having a high thermal conductivity, such as copper.

The finger 508 includes a first end 520 coupled to the second surface 516 of the base 504 and a second end 524 spaced from the first end 520 and coupled to the trap 270 (FIG. 7). In some aspects, the second end 524 includes an opening 528 configured to receive the trap 270. For example, the opening 528 can be a rectangular aperture configured to receive and secure the ion trap 270, of which the temperature is controlled by the cryostat during operation of the QIP system 200.

As shown in FIGS. 6-7, the isolation unit 600 is coupled between the first plate 412 of the cryostat 400 and the base 504 of the cold finger 500. The isolation unit 600 is configured to facilitate thermal conductivity between the base 504 of the cold finger 500 and the first plate 412 of the cryostat 400 and prevent electrical conductivity between the base 504 of the cold finger 500 and the first plate 412 of the cryostat 400. In some aspects, a second isolation unit 600 may be coupled between the second end 524 of the finger 508 and the ion trap 270.

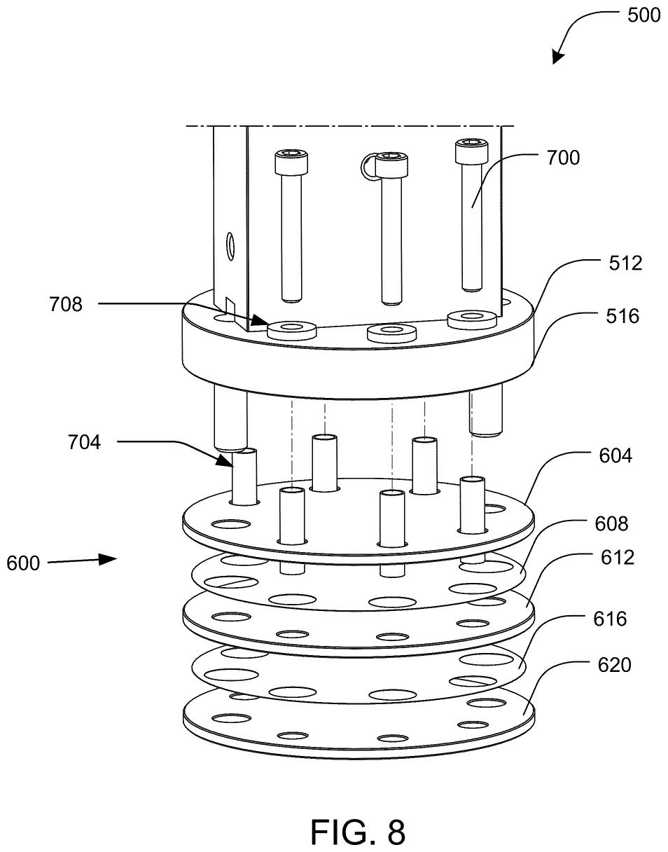

FIG. 8 illustrates an exploded view of the isolation unit 600. As shown in FIG. 8, the isolation unit includes a first spacer plate 604, a first indium layer 608, a dielectric crystal plate 612, a second indium layer 616, and a second spacer plate 620.

The first and second spacer plates 604, 620 may be or include a material that is both thermally and electrically conductive, such as metal. In some aspects, the first and second spacer plates 604, 620 may be or include gold-plated copper. In some aspects, the spacer plates 604, 620 may be omitted. In such aspects, only the dielectric crystal plate 612 may be directly placed between the first plate 412 of the cryostat 400 and the cold finger 500.

The dielectric crystal plate 612 may be or include a material that has a high thermal conductivity and a high electrical resistance. For example, the crystal structure of the dielectric crystal plate 612 may be configured to transfer heat through phonon excitations. In contrast, in metals, heat is transferred via free electrons. Since there are no free electrons in the crystal structure of the dielectric crystal plate 612, electrical signals do not propagate through the dielectric crystal plate 612, but phonons effectively transfer heat efficiently through the dielectric crystal plate 612. For example, in some aspects a thermal conductivity of the dielectric crystal plate 612 may be from about 500 Watts per meter-Kelvin (W/mK) to about 3000 W/mK when measured at 10 K. In some aspects, an electrical resistivity of the dielectric crystal plate 612 may be from about 1×10¹² ohm-meters (Ωm) to about 1×10¹⁵ Ωm when measured at 300 K. In some aspects, the dielectric crystal plate 612 may be or include diamond, sapphire, or quartz. In some aspects, a compressive strength of the dielectric crystal plate 512 may be from about 1 giga pascal (GPa) to about 20 GPa. In some aspects, the dielectric crystal plate 612 may have a thickness of approximately 1/16 inches or less.

In some aspects, the first indium layer 608 may overlie a first surface 624 of the dielectric crystal plate 612. The second indium layer 616 may overlie a second surface 628 of the dielectric crystal plate 612. In some aspects, the first and second indium layers 608, 616 may have a thickness of approximately 6×10⁻² inches. In some aspects, the indium layers 608, 616 may improve thermal conductivity between the dielectric crystal plate 612 and the first and second spacer plates 604, 620. In some aspects, the indium layers 608, 616 may improve thermal conductivity between the dielectric crystal plate 612, the first plate 412 of the cryostat 400, and the base 504 of the cold finger 500.

In the illustrated aspect, the dielectric crystal plate 612, the first and second spacer plates 604, 620, and the first and second indium layers 608, 616 are substantially circular in shape. In other aspects, the dielectric crystal plate 612, the first and second spacer plates 604, 620, and the first and second indium layers 608, 616 may be different geometric shapes, such as rectangular, triangular, square, oval, ellipsoid, and so forth. In some aspects, the dielectric crystal plate 612, the first and second spacer plates 604, 620, and the first and second indium layers 608, 616 may have the same shape as the first plate 416 of the cryostat 400.

Referring now, to FIGS. 6-8, the isolation unit 600 is positioned between the first plate 410 of cryostat 400 and the base 504 of the cold finger. In the aspect illustrated in FIGS. 7 and 8, the dielectric crystal plate 612 is positioned between the first and second indium layers 608, 616, the first spacer plate 604 is adjacent the first indium layer 608, and the second spacer plate 620 is adjacent the second indium plate 616. In some aspects, the isolation unit 600 may only include the dielectric crystal plate 612 and the first and second indium layers 608, 616. In some aspects, the isolation unit 600 may only include the dielectric crystal plate 612.

The isolation unit 600 and the cold finger 500 may be removably coupled to the cryostat 400 via threaded connectors 700 such as screws or bolts 700. In some aspects, the threaded connectors 700 may be positioned within ceramic dowels 704. Ceramic washers 708 may be positioned between heads of the threaded connectors 700 and the base 504 of the cold finger 500. In such aspects, the ceramic dowels 704 and washers 708 may prevent electrical conductivity between the cryostat 400, the isolation unit 600, and the cold finger 500. In some aspects, the threaded connectors 700 may be made from a non-conductive material, such as polyether ether ketone (PEEK), Teflon, ceramic, and so forth. In such aspects, the ceramic dowels 704 and washers 708 may be omitted.

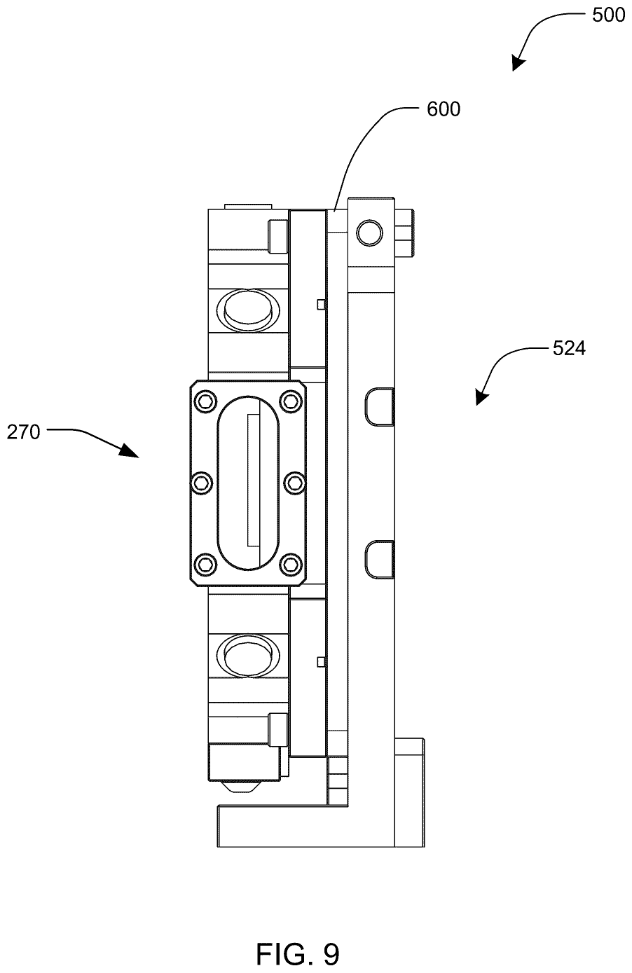

Although FIGS. 4-8 show the isolation unit 600 coupled between the first plate 412 of the cryostat 400 and the base 504 of the cold finger 500, in some aspects, the isolation unit 600 may be positioned in other locations according to refinements of the present embodiment. For example, as shown in FIG. 9, the isolation unit 600 may be positioned between the second end 524 of the finger 508 and the trap 270. In such aspects, a cross-sectional shape of the components of the isolation unit 600 be the same as a cross-sectional shape of the second end 524 of the finger 508 or a cross-sectional shape of the trap 270. In such aspects, positioning the isolation unit 600 between the second end 524 of the finger 508 and the trap 270 may allow an isolation unit 600 with lower compressive strength to be used since the isolation unit 600 may not have to carry the mass of the cold finger 500. In some aspects, a first isolation unit 600 may be positioned between the first plate 400 of the cryostat and the base 504 of the cold finger 500 and a second isolation unit 600 may be positioned between the second end 524 of the finger 508 and the trap 270. In other aspects, one isolation unit 600 may be used. In such aspects, the isolation unit 600 in one of the example locations disclosed herein. The isolation units 600 generally may have the same configuration in an example aspect when implemented as the first and second isolation units 600.

In some aspects, a first isolation unit 600 may be coupled between the first plate 412 of the cryostat 400 and the base 504 of the cold finger 500 and a second isolation unit 600 may be positioned between the second end 524 of the finger 508 and the ion trap 270.

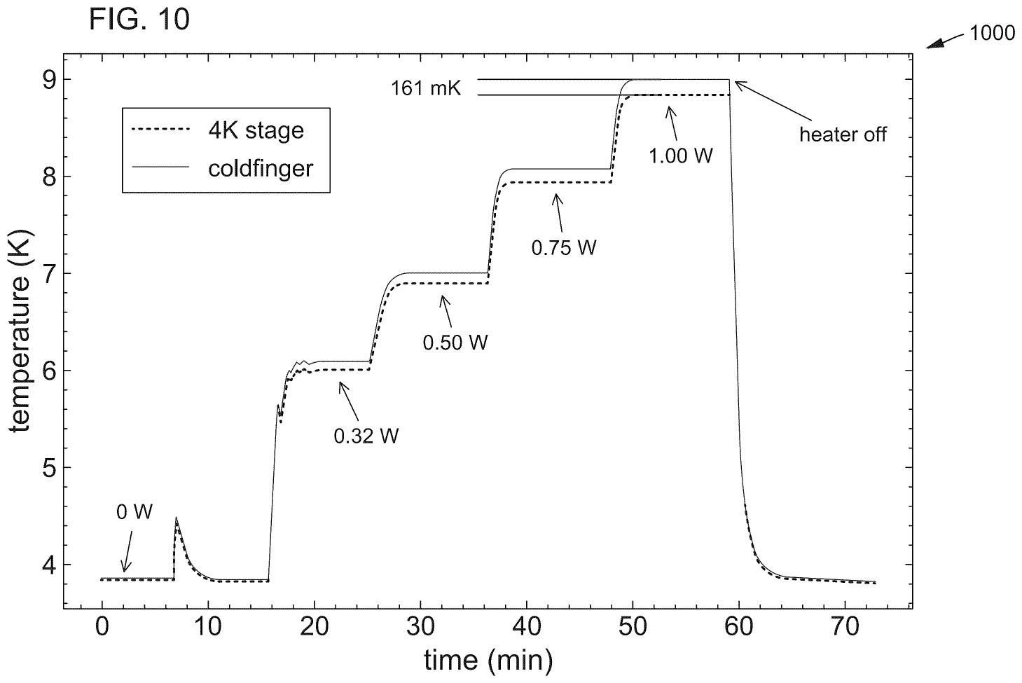

FIG. 10 illustrates a plot 1000 showing the heat load response at a 1 W thermal load of a cold finger coupled to a 4K cooling plate of a cryostat that does not include an isolation unit such as the isolation unit 600 between the 4K cooling plate and the cold finger. As shown in FIG. 10, the temperature of the cold finger is substantially similar to the temperature of the 4K plate, indicating efficient thermal conductivity between the 4K plate of the cryostat and the cold finger.

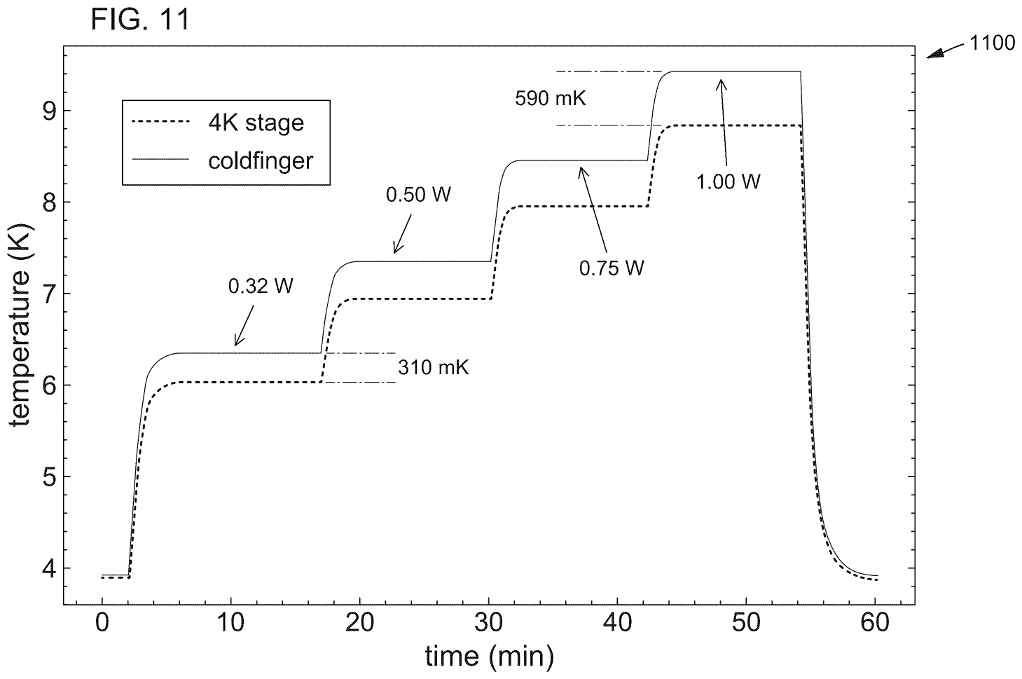

FIG. 11 illustrates a plot 1100 showing the heat load response at a 1 W thermal load of a cold finger 500 coupled to the 4 K cooling plate 412 of a cryostat 409 includes the isolation unit 600 between the cooling plate 412 and the cold finger 500. As shown in FIG. 11, the temperature of the cold finger 500 is substantially similar to the temperature of the plate 412, indicating that the isolation unit 600 allows efficient thermal conductivity between the plate 412 of the cryostat 400 and the cold finger 500.

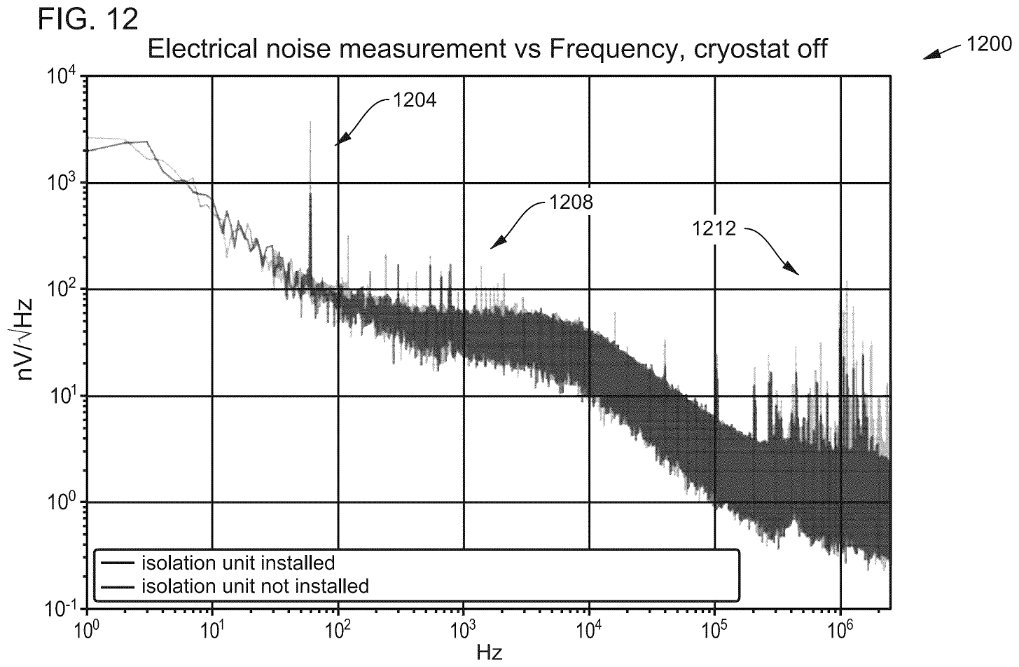

FIG. 12 illustrates a plot 1200 showing electrical noise versus frequency for two example QIP systems when the cryostat is turned off. The orange line shows the plot for an example QIP system that does not include an isolation unit such as the isolation unit 600. The blue line shows the plot for an example QIP system that includes an isolation unit such as the isolation unit 600. As shown in FIG. 12, the example QIP system that includes the isolation unit 600 has less noise than the example QIP system that does not include an isolation unit. This is shown, for example, at least in the sections 1204, 1208, and 1212 of the plot 1200.

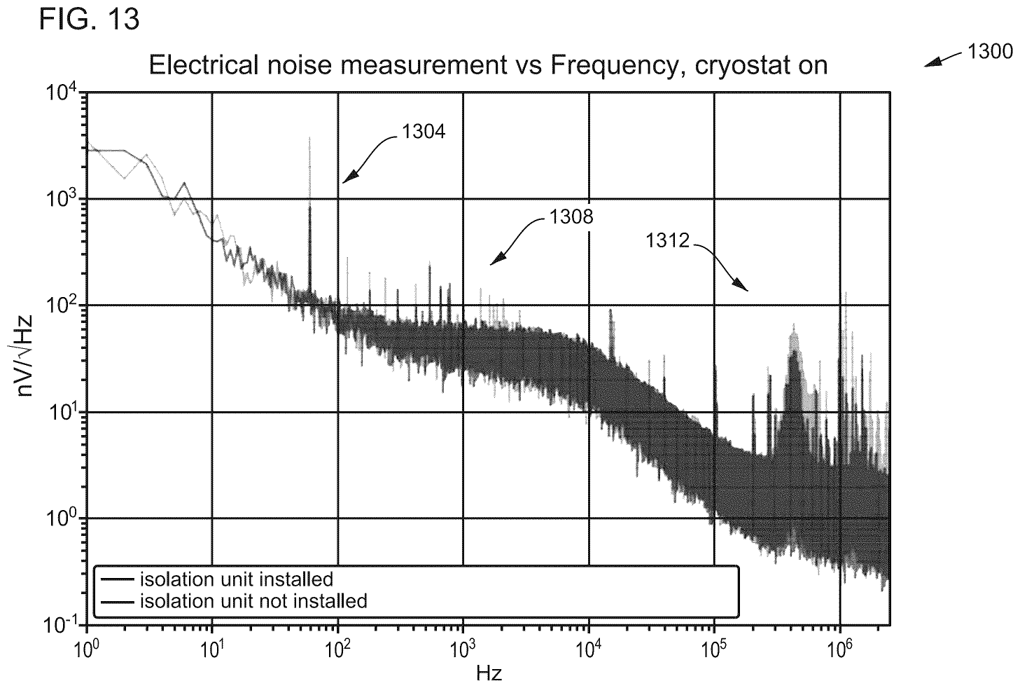

FIG. 13 illustrates a plot 1300 showing electrical noise versus frequency for two example QIP systems when the cryostat is turned on. The orange line shows the plot for an example QIP system that does not include an isolation unit such as the isolation unit 600. The blue line shows the plot for an example QIP system that includes an isolation unit such as the isolation unit 600. As shown in FIG. 13, the example QIP system that includes the isolation unit 600 has less noise than the example QIP system that does not include an isolation unit. This is shown, for example, at least in the sections 1204, 1308, and 1312 of the plot 1300.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A cold finger for use with a quantum information processing (QIP) system including a cryostat, the cold finger comprising:
a planar base including opposing first and second surfaces;
a finger including a first end coupled to the second surface of the planar base and a second end configured to engage an ion trap; and
an isolation unit including a dielectric crystal plate that is configured to isolate the ion trap from electrical noise generated by the cryostat when the cryostat is controlling a temperature of the ion trap.

2. The cold finger of claim 1, wherein the dielectric crystal plate includes diamond, sapphire, or quartz.

3. The cold finger of claim 1, wherein an electrical resistivity of the dielectric crystal plate is from 1×10¹² ohm-meters (Ωm) to 1×10¹⁵ Ωm.

4. The cold finger of claim 3, wherein a thermal conductivity of the dielectric crystal plate is from 500 Watts per meter-Kelvin (W/mK) to 3000 W/mK.

5. The cold finger of claim 1, wherein a compressive strength of the dielectric crystal plate is between 1 giga pascal (GPa) and 20 GPa.

6. The cold finger of claim 1, wherein the isolation unit includes at least one metal plate.

7. The cold finger of claim 6, wherein the at least one metal plate includes gold-plated copper.

8. The cold finger of claim 1, wherein the isolation unit includes at least one indium layer overlying the dielectric crystal plate.

9. The cold finger of claim 1, wherein the isolation unit includes a first metal plate adjacent the first surface of the planar base, a first indium layer adjacent the first metal plate, the dielectric crystal plate adjacent the first indium layer, a second indium layer adjacent the dielectric crystal plate, and a second metal plate adjacent the second indium layer and the cooling plate of the cryostat.

10. The cold finger of claim 1, wherein the isolation unit is positioned between a cooling plate of the cryostat and the ion trap.

11. The cold finger of claim 10, wherein the isolation unit is between the first surface of the planar base and the cooling plate of the cryostat.

12. The cold finger of claim 10, wherein the isolation unit is positioned between the second end of the cold finger and an ion trap.

13. An isolation unit for use with a quantum information processing (QIP) system including a cryostat, the isolation unit comprising:
a dielectric crystal plate configured to be positioned between a cooling plate of the cryostat and a component to be isolated, the dielectric crystal plate having a first surface, a second surface opposite the first surface, a first indium layer overlying the first surface, and a second indium layer overlying the second surface; and
wherein the isolation unit is configured to facilitate thermal conductivity between the cooling plate and the component to be isolated and prevent electrical noise between the cooling plate and the component to be isolated.

14. The isolation unit of claim 13, wherein the dielectric crystal plate includes diamond, sapphire, or quartz.

15. The isolation unit of claim 13, wherein an electrical resistivity of the dielectric crystal plate is from 1×10¹² ohm-meters (Ωm) to 1×10¹⁵ Ωm.

16. The cold finger of claim 15, wherein a thermal conductivity of the dielectric crystal plate is from 500 Watts per meter-Kelvin (W/mK) to 3000 W/mK.

17. The cold finger of claim 13, wherein a compressive strength of the dielectric crystal plate is between 1 giga pascal (GPa) and 20 GPa.

18. The isolation unit of claim 13, wherein the isolation unit includes a first metal plate adjacent the first indium layer and a second metal plate adjacent the second indium layer.

19. The isolation unit of claim 18, wherein the first and second metal plates include gold-plated copper.

20. The isolation unit of claim 13, wherein the component to be isolated includes an ion trap.
